(19) United States
(12) Patent Application Publication
(10) Pub. No.: US 2007/0023468 A1
(43) Pub. Date: Feb. 1, 2007

(54) Rotatable utility belt mount

(75) Inventor: Vincent Gregory Ford, Puyallup, WA (US)

Correspondence Address: ROBERT D. VARITZ, P.C., 4915 S.E. 33RD PLACE, PORTLAND, OR, 97202, US

(73) Assignee: Blade-Tech Industries, Inc.

(21) Appl. No.: 11/194,863

(22) Filed: Jul. 31, 2005

(51) Int. Cl. A01K 97/04; F41C 33/02

(52) U.S. Cl. 224/197; 224/198

(57) ABSTRACT

A rotatable utility belt mount for use with a utility belt and an object to be rotatably, removable secured to the utility belt includes a first circular, planar disk element, having an engagement structure thereon for engaging a second circular, planar disk, a second circular, planar disk element, having an engagement structure thereon for engaging, in a rotatable, removal fashion, the engagement structure of the first circular, planar disk element; an orientation mechanism for restricting rotational orientation of the second circular, planar disk element relative to the first circular, planar disk element; and a locking mechanism which restricts relative rotational movement and allows separation of the second circular, planar disk element from the first circular, planar disk element when the second circular, planar disk element is oriented to a specific orientation relative to the first circular, planar disk element.

### FIELD OF THE INVENTION

This invention relates to utility belts, such as worn by law enforcement and military personnel, and specifically to a rotatable mount for securing and releasing a holder or holster to the utility in an adjustable fashion.

### BACKGROUND OF THE INVENTION

A variety of devices are carried on utility belts by law enforcement officers and military personnel. Perhaps the most common item carried on a utility belt is a holster for a handgun, followed by a holster for a TASER™, a baton, pepper spray, radio, handcuffs, etc. Modern holsters offer a wide variety of features to protect a handgun within the holster and to secure the gun against unauthorized use. An example of such a holster is that manufactured by Blade-Tech Industries, Inc., which is molded to fit the contours of a specific make and model of firearm. Such holsters typically have a hard shell or skeleton made from a tough abrasion resistant polymer, such as glass-filled nylon, polypropalene, modified polypropalene or Kydex® PVC-acrylic alloy. Because the holster and/or the handgun must be manipulated to release the handgun from the holster, it is desirable rigidly to secure the holster to the belt of the user so that the handgun may quickly be released from the holster. One prior art method for rigidly securing a holster to a belt involves the use of a utility clip, as shown in U.S. Pat. No. 6,145,169 to Terzuola et al., granted Nov. 14, 2000, for Locking, Removable Belt Clip. The belt clip of the '169 patent includes adjustable provisions to accommodate a variety of belt widths, and has one side thereof fixed to a holster mechanism, while the other side extends about the wearer-side of the utility belt. While the '169 belt clip is functional for its intended purpose, it does not allow, by design, for rotation of an article attached thereto.

While holsters provide protection for the handgun and the handgun user, the holsters themselves can be uncomfortable to wear, particularly by law enforcement personnel who must carry handguns while working. For example, in many patrol cars, especially those with bucket seats, the holster is pushed upward by the seat and causes great discomfort. A non-rotatable connection between a holster and a utility belt aggravates this discomfort. Likewise, most officers must remove their baton from its holster to enter a patrol car, which requires that the officer grab the baton when exiting the patrol car.

There may be times when a handgun user wishes to remove the handgun and holster from the belt, for example when riding in a car. In the case of plain-clothes officers, a paddle holster is often worn, however, uniformed officers generally carry a sidearm in a visible holster carried on a utility belt. Removing the handgun from its holster, however, reduces the protection afforded by the holster to a handgun, particularly where the holster secures the handgun within the holster to prevent unauthorized use of the handgun. In order to keep the handgun in the holster, the handgun user must remove the a conventional belt loop from the belt by partially removing the belt and sliding the belt loop off of the belt. This may be difficult with used with modern law enforcement utility belts, which may have additional items secured to the utility belt. When the holster is removed from the belt, there is a further need to again secure the holster. For example, if a holster is removed in a car, it is desirable to secure the holster so that the holster does not move around within the interior of the car while the car is in motion.

Users also often have individual preferences for the orientation of a holster relative to a utility belt. For example, some holsters have locking mechanisms for securing the handgun, which require the handgun to be withdrawn at a certain angle relative to the holster. It may be the desire of a handgun wearer to secure the holster to the belt at an offset angle.

What is therefore desired is a holster securement system that increases the comfort of wearing a holster that may be securely and rigidly attached to a belt, and which allows adjustment of the angular orientation of the holster relative to the belt, and allows the object rotatably secured to the utility belt to easily be roved from the utility belt. A number of prior art devices are known for adjusting the orientation of various holster devices to a utility belt.

U.S. Pat. No. 5,641,102 to Hellwig, granted Jun. 24, 1997, depicts a rotation mechanism, having a variety of configuration, which allows both rotational positioning and planar positioning, so that the holster may be canted to various angles relative to the longitudinal axis of the belt engaging portion.

U.S. Pat. No. 6,161,741 to French, granted Dec. 19, 2000, depicts a spring-biased rotational mechanism featuring recesses and prongs to adjust the rotational orientation of the holster to a holster hanger. This mechanism allows for rotation of the holster while being worn by a user. U.S. Pat. No. 6,685,067 B2 to French, granted Feb. 3, 2004, depicts a holster which may be rotated relative to a holster hanger, and which may also be removed from the hanger, and which may be positioned in different vertical positions on the holster hanger.

U.S. Pat. No. 6,752,299 B2 to Shetler et al., granted Jun. 22, 2004, depicts a rotational-removable carrying device for a mobile phone.

U.S. Patent Publication No. 2003/0085244 A1 of Parsons, published May 8, 2003, depicts a rotatable baton carrying device.

U.S. Pat. No. 3,952,930 to Baldocchi, granted Apr. 27, 1976, depicts a rotational device for fastening an object to a belt, using conformal grooves on each half of the device, however, this device does not allow for rotation of the object relative to the belt once the device is adjusted.

U.S. Pat. No. 5,504,001 to Nichols, granted Mar. 12, 1985, depicts a rotational device for fastening an object to a belt, using conformal prongs and recesses on each half of the device. This device does not allow for rotation of the object relative to the belt once the device is adjusted.

U.S. Pat. No. 6,371,341 B1 to Clifton, Jr., granted Apr. 16, 2002, depicts a release mechanism for a holster which requires the holster to be rotated before the weapon may be drawn.

U.S. Patent Publication No. 2004/0035897 A1 of Salentine et al., published Feb. 26, 2004, depicts a rotationally mounted key carrier.

### SUMMARY OF THE INVENTION

A rotatable utility belt mount for use with a utility belt and an object to be rotatably, removable secured to the utility belt includes a first circular, planar disk element, having a first engagement structure thereon for engaging a second circular, planar disk, a second circular, planar disk element, having a second engagement structure thereon for engaging, in a rotatable, removal fashion, the engagement structure of the first circular, planar disk element; an orientation mechanism for restricting rotational orientation of the second circular, planar disk element relative to the first circular, planar disk element, wherein the second circular, planar disk element is fully rotatable relative to the first circular, planar disk element, wherein the orientation mechanism provides for incremental locking of the second circular, planar disk element relative to the first circular, planar disk element; and a locking mechanism, which includes a spring for biasing a locking pin to a locked position, and which allows separation of the second circular, planar disk element from the first circular, planar disk element when the second circular, planar disk element is oriented to a specific orientation relative to the first circular, planar disk element.

It is an object of the invention to provide a rotatable mount for fastening an object to a utility belt.

Another object of the invention is to provide a rotatable mount which allows an object carried thereon the be removed with a minimum amount of contortion and effort.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 depicts the rotatable utility belt mount in an environmental, exploded view.

FIG. 2 depicts the second, circular planar element of the rotatable utility belt mount.

FIG. 3 depicts the first, circular planar element of the rotatable utility belt mount.

### DETAILED DESCRIPTION OF THE PREFERRED EMBODIMENTS

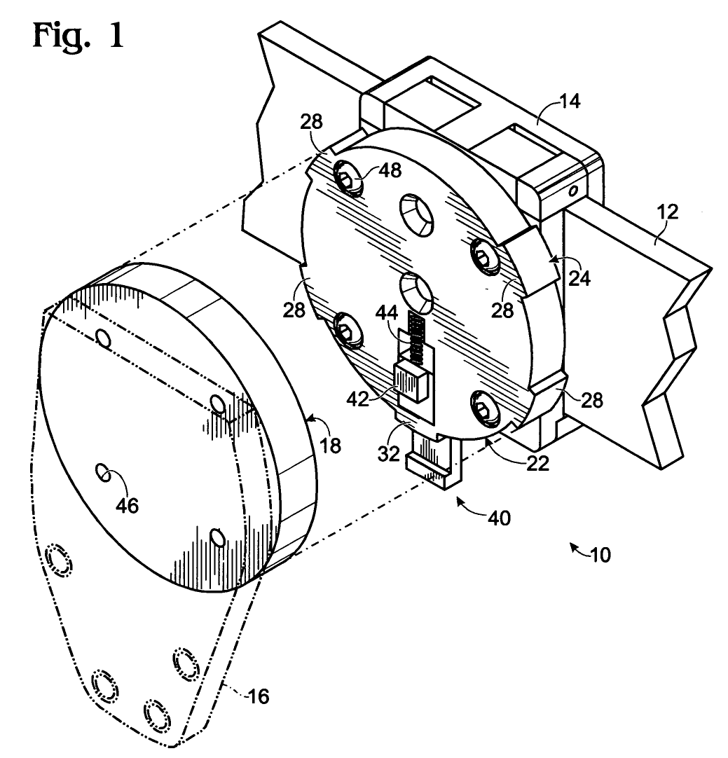

Referring now to FIGS. 1-3, the invention is rotatable utility belt mount, shown generally at 10 in FIG. 1, which is intended for use with a utility belt 12, a utility belt clip 14, and object 16 to be rotatably, removable secured to the utility belt. Rotatable utility belt mount 10 includes, and now referring to FIGS. 1-3, a first circular, planar disk element 18, having a first engagement structure 20 thereon for engaging a second circular, planar disk element 22, having a second engagement structure 24 thereon for engaging, in a rotatable, removal fashion, first engagement structure 20 of first circular, planar disk element 18.

First engagement structure 20 includes symmetrically arranged wasted regions 26 for receiving conformal symmetrically arranged lugs 28 of second engagement structure 24. First engagement structure 20 further includes a non-symmetrical wasted area 30 and second engagement structure 24 includes a non-symmetrical lug 32 wherein, with the symmetrical lugs and symmetrical wasted areas aligned, and with the non-symmetrical lug and the non-symmetrical wasted area aligned, the first circular, planar disk element and the second, circular planar disk element are separable.

An orientation mechanism 34 restricts rotational orientation of first circular, planar disk element 18 relative to second circular, planar disk element 22. Second circular, planar disk element 22 is fully rotatable relative to first circular, planar disk element 18 when orientation mechanism 34 is in an unlocked condition. Orientation mechanism 34 provides for incremental locking of second circular, planar disk element 22 relative to first circular, planar disk element 18, and includes a circular array of notches 36, disposed about a circular wasted area 38, which, in the preferred embodiment, is located on first circular, planar disk element 18. Orientation mechanism 34 includes a locking mechanism 40, having a locking pin 42 for selectively engaging a notch in circular array of notches 36, or for travel in the un-notched portion of circular wasted area 38. Locking pin 42 is spring biased to a locked position by a spring 44, which is captured in the second circular, planar disk element. In the preferred embodiment, circular array of notches 36 extends about only a portion of the circular wasted area 38, and the remainder of circular wasted area 38 allows free rotatable movement of locking pin 42, and first circular, planar disk element relative to second circular, planar disk element.

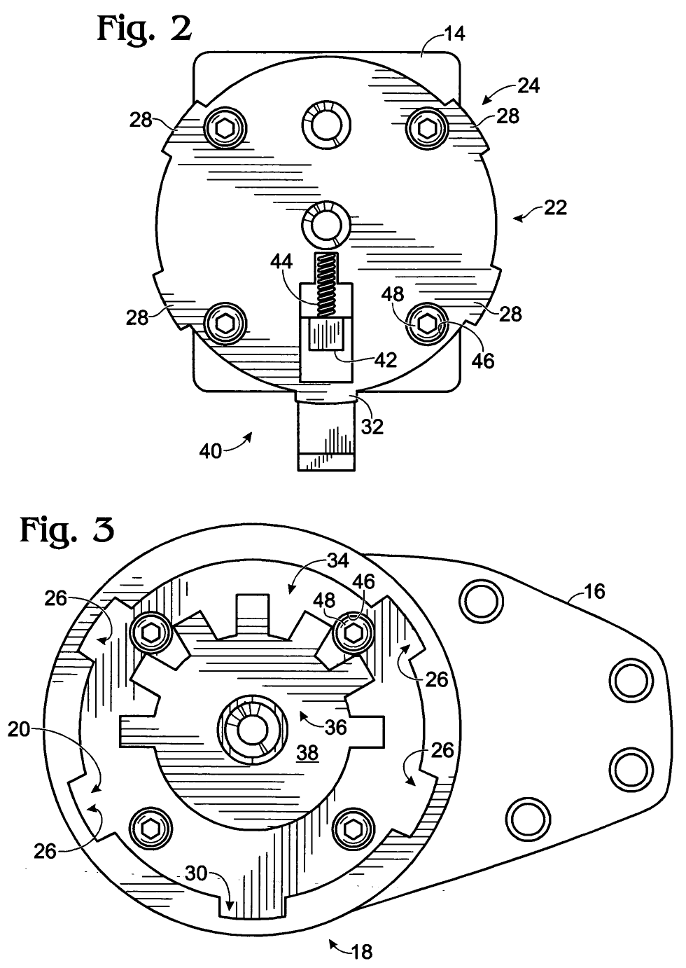

Locking mechanism 40, allows for rotation of first circular, planar disk element 18 and second circular, planar disk element 22 to a disengaged position to facilitate separation of second circular, planar disk element 22 from first circular, planar disk element 18 when second circular, planar disk element is oriented to a specific orientation relative to first circular, planar disk element when locking mechanism 40 is moved to an unlocked position, and when first circular, planar disk element and second circular, planar disk element are oriented with symmetrical wasted area 26 aligned with symmetrical lugs 28 and non-symmetrical wasted area 30 aligned with non-symmetrical lug 32. This condition occurs when first circular, planar disk element of FIG. 3 is flipped 180° horizontally and placed over second circular, planar disk element of FIG. 2, and locking pin 42 is shifted to its unlocked position, i.e., towards the center of the circular, planar disk element.

The first circular, planar disk element and said second circular, planar disk element include fastener receptacles 46 for receiving fasteners 48 to fasten first circular, planar disk element 18 to object 16, and to fasten second circular, planar disk element 22 to utility belt clip 14.

In the preferred embodiment, the components of the rotatable utility belt mount are fabricated of 33% glass-filled nylon.

Thus, a rotatable utility belt mount has been disclosed. It will be appreciated that further variations and modifications thereof may within the scope of the invention as defined in the appended claims.

I claim:

1. A rotatable utility belt mount for use with a utility belt, a utility belt clip, and object to be rotatably, removable secured to the utility belt, comprising:
a first circular, planar disk element, having a first engagement structure thereon for engaging a second circular, planar disk,
a second circular, planar disk element, having a second engagement structure thereon for engaging, in a rotatable, removal fashion, said engagement structure of said first circular, planar disk element,
an orientation mechanism for restricting rotational orientation of the second circular, planar disk element relative to the first circular, planar disk element, wherein said second circular, planar disk element is fully rotatable relative to said first circular, planar disk element, wherein said orientation mechanism provides for incremental locking of said second circular, planar disk element relative to said first circular, planar disk element; and
a locking mechanism, which includes a spring for biasing the locking mechanism to a locked position, and which allows separation of said second circular, planar disk element from said first circular, planar disk element when said second circular, planar disk element is oriented to a specific orientation relative to said first circular, planar disk element.

2. The rotatable utility belt mount of claim 1 wherein said orientation mechanism includes a circular array of notches disposed about a circular wasted area, wherein said locking mechanism includes a locking pin for engaging a notch.

3. The rotatable utility belt mount of claim 2 wherein said circular array of notches is located on said first circular, planar disk element and wherein said locking pin is carried on said second circular, planar disk element.

4. The rotatable utility belt mount of claim 2 wherein said circular array of notches extends about only a portion of the circular wasted area, and wherein the remainder of said circular wasted area allows free rotatable movement of said locking pin.

5. The rotatable utility belt mount of claim 1 wherein said first circular, planar disk element and said second circular, planar disk element include fastener receptacles for receiving fasteners to fasten said first circular, planar disk element to the object, and to fasten said second circular, planar disk element to a utility belt clip.

6. The rotatable utility belt mount of claim 1 wherein said first engagement structure includes symmetrically arranged wasted regions for receiving conformal symmetrically arranged lugs of said second engagement structure, and which further includes a non-symmetrical wasted area on said first engagement mechanism and a non-symmetrical lug on said second engagement mechanism; wherein, with said symmetrical lugs and wasted areas aligned, and said non-symmetrical lug and wasted area aligned, and with said locking mechanism in an unlocked position, said first circular, planar disk element and said second, circular planar disk element are engagable.

7. A rotatable utility belt mount for use with a utility belt and an object to be rotatably, removable secured to the utility belt, comprising:
a first circular, planar disk element, having a first engagement structure thereon for engaging a second circular, planar disk;
a second circular, planar disk element, having a second engagement structure thereon for engaging, in a rotatable, removal fashion, said engagement structure of said first circular, planar disk element;
wherein said first engagement structure includes symmetrically arranged wasted regions for receiving conformal symmetrically arranged lugs of said second engagement structure, and which further includes a non-symmetrical wasted area on said first engagement mechanism and a non-symmetrical lug on said second engagement mechanism; wherein, with said symmetrical lugs and wasted areas aligned, and said non-symmetrical lug and wasted area aligned, and with said locking mechanism in an unlocked position, said first circular, planar disk element and said second, circular planar disk element are engagable;
an orientation mechanism for restricting rotational orientation of the second circular, planar disk element relative to the first circular, planar disk element, wherein said second circular, planar disk element is fully rotatable relative to said first circular, planar disk element, wherein said orientation mechanism provides for incremental locking of said second circular, planar disk element relative to said first circular, planar disk element; and
a locking mechanism, which includes a spring for biasing the locking mechanism to a locked position, and which allows separation of said second circular, planar disk element from said first circular, planar disk element when said second circular, planar disk element is oriented to a specific orientation relative to said first circular, planar disk element.

8. The rotatable utility belt mount of claim 7 wherein said orientation mechanism includes a circular array of notches disposed about a circular wasted area, wherein said locking mechanism includes a locking pin for engaging a notch.

9. The rotatable utility belt mount of claim 8 wherein said circular array of notches is located on said first circular, planar disk element and wherein said locking pin is carried on said second circular, planar disk element.

10. The rotatable utility belt mount of claim 8 wherein said circular array of notches extends about only a portion of the circular wasted area, and wherein the remainder of said circular wasted area allows free rotatable movement of said locking pin.

11. The rotatable utility belt mount of claim 8 wherein said locking pin is biased by a spring which is captured between said locking pin and said second circular, planar disk element.

12. The rotatable utility belt mount of claim 7 wherein said first circular, planar disk element and said second circular, planar disk element include fastener receptacles for receiving fasteners to fasten said first circular, planar disk element to the object, and to fasten said second circular, planar disk element to a utility belt clip.

13. A rotatable utility belt mount for use with a utility belt, a utility belt clip, and object to be rotatably, removable secured to the utility belt, comprising:
a first circular, planar disk element, having a first engagement structure thereon for engaging a second circular, planar disk,
a second circular, planar disk element, having a second engagement structure thereon for engaging, in a rotatable, removal fashion, said engagement structure of said first circular, planar disk element,
an orientation mechanism for restricting rotational orientation of the second circular, planar disk element relative to the first circular, planar disk element, wherein said second circular, planar disk element is fully rotatable relative to said first circular, planar disk element, wherein said orientation mechanism provides for incremental locking of said second circular, planar disk element relative to said first circular, planar disk element, wherein said orientation mechanism includes a circular array of notches disposed about a circular wasted area, wherein said locking mechanism includes a locking pin for engaging a notch; and
a locking mechanism, which includes a spring for biasing the locking mechanism to a locked position, and which allows separation of said second circular, planar disk element from said first circular, planar disk element when said second circular, planar disk element is oriented to a specific orientation relative to said first circular, planar disk element.

14. The rotatable utility belt mount of claim 13 wherein said circular array of notches is located on said first circular, planar disk element and wherein said locking pin is carried on said second circular, planar disk element.

15. The rotatable utility belt mount of claim 13 wherein said circular array of notches extends about only a portion of the circular wasted area, and wherein the remained of said circular wasted area allows free rotatable movement of said locking pin.

16. The rotatable utility belt mount of claim 13 wherein said first circular, planar disk element and said second circular, planar disk element include fastener receptacles for receiving fasteners to fasten said first circular, planar disk element to the object, and to fasten said second circular, planar disk element to a utility belt clip.

17. The rotatable utility belt mount of claim 13 wherein said first engagement structure includes symmetrically arranged wasted regions for receiving conformal symmetrically arranged lugs of said second engagement structure, and which further includes a non-symmetrical wasted area on said first engagement mechanism and a non-symmetrical lug on said second engagement mechanism; wherein, with said symmetrical lugs and wasted areas aligned, and said non-symmetrical lug and wasted area aligned, and with said locking mechanism in its unlocked position, said first circular, planar disk element and said second, circular planar disk element are engagable.
